(19) United States
(12) Patent Application Publication
(10) Pub. No.: US 2009/0125645 A1
(43) Pub. Date: May 14, 2009

(54) SYSTEM AND METHOD FOR SUPPORTING MULTIPLE TOKENS HAVING A SMART CARD TO CONTROL PARAMETERS OF A FLASH MEMORY DEVICE

(75) Inventors: Sylvain Prevost, Austin, TX (US); Ksheerabdhi Krishna, Cedar Park, TX (US); Ruchirkumar D Shah, San Jose, CA (US); Mehdi Asnaashari, Danville, CA (US)

Correspondence Address: THE JANSSON FIRM, 9501 N. CAPITAL OF TX HWY #202, AUSTIN, TX, 78759, US

(73) Assignee: GEMALTO INC, Austin, TX (US)

(21) Appl. No.: 11/938,777

(22) Filed: Nov. 12, 2007

(51) Int. Cl. G06F 3/00

(52) U.S. Cl. 710/13

(57) ABSTRACT

A system and method to control a device having at least one configurable parameter. Enumerating the device as a first peripheral device and as a second peripheral device wherein the first peripheral device corresponds to a first microcontroller connected to a storage medium and the second peripheral device corresponds to a second microcontroller. Controlling the at least one configurable parameter of the first microcontroller with respect to the storage medium by the second microcontroller. On initialization of the device, transmitting the at least one configurable parameter from the second microcontroller to the first microcontroller. Other systems and methods are disclosed.

### CROSS-REFERENCE TO RELATED APPLICATIONS

This application is related to the following patent applications co-filed herewith:

<<List of the other six applications to be added by amendment>>

### BACKGROUND OF THE INVENTION

The present invention relates generally to secure USB flash memory devices and more particularly to USB flash memory devices having both a microcontroller and a smart card.

With the small physical size of computer memories having large address spaces, it has become possible to store relatively large quantities of data on small portable memory devices. This portability has made it possible for users to literally carry their important data in their pocket either for the purpose of sharing the data with other individuals or to have information available without carrying bulkier and less portable forms of data storage.

USB flash drives are one example of such small portable devices that are becoming a very popular mechanism for storing computerized information and for physically moving the stored information from one computer to another. There are many popular uses; some common uses include personal data transport and data transfer.

With the portability of data storage devices come security risks. There have been several highly publicized cases of private data being lost from misplaced or stolen laptop computers. Similar risks arise with the use of USB flash drives: being small, they are easily misplaced, often they are carried in a user's pocket and can then, like other small items carried in that fashion, inadvertently fall out of the pocket undetected. In the event of loss of the device, if the owner of the device has stored sensitive private information on it, that person would be more comfortable knowing that the private data could not be accessed without authorization, e.g., without being authenticated as the owner of the device.

There is also a growing culture of using USB flash drives to move data to computers belonging to persons other than the owner of the USB flash drive. In that scenario the owner of the USB flash drive provides the USB flash drive to another person for connection to that persons computer via a USB port either for the purpose of receiving data files from the owner of the computer or vice versa. However, because the owner of the USB flash drive does not typically have control of the computer, the USB flash drive owner is subjected to having data moved, intentionally or unintentionally, from the USB flash drive to the computer to which it is being attached, or viewed by the owner of the computer. Furthermore, the owner of the computer could, again either with intent or inadvertently, cause information stored on the USB flash drive to be deleted or corrupted.

Thus it is desirable to avoid the threat of being subjected to some form of attack from the computer to which the drive is attached.

Encryption technology is available on many computers. Thus, one way to avoid some of the aforementioned problems is to use the encryption processing capabilities to encrypt and decrypt files stored on the USB flash memory device. While that solution may work to solve specific needs of particular users, it is not a good general solution to the data security problems that arise with USB flash memory devices. One problem is that multiple encryption standards exist. Thus, the encryption technology used to encrypt a file on one computer may not be available when the same file is to be decrypted on another computer. A more severe issue is that often a user would store the encryption key on the computer with which the USB flash memory device is most often used. Thus, the likelihood that the computer and USB flash memory device are lost together or stolen together is high and consequently a hacker may be able to find the encryption key for the USB flash memory device somewhere on the computer.

To address the above-mentioned concerns, several manufacturers, including, Lexar Media, Inc. of Fremont, Calif. and Kingston Technology Company, Inc. of Fountain Valley, Calif., have introduced USB flash memory devices that provide encryption of a data zone having private data. The encryption and decryption is performed by the USB flash memory microcontroller and the encryption key is stored inside the microcontroller. While this solution provides a higher level of security than USB flash memory devices that have no security features and also improves security with respect to using a host computer for encryption and decryption, it is a solution that is vulnerable to certain attacks. For example, denial of service attacks may be launched against files in the private data zone by deleting files from that area of the device. As discovered by the smart card industry, hackers have developed many clever techniques for deducing the activity inside a microcontroller, for example, examining power consumption patterns, and can use those techniques for determining encryption keys.

From the foregoing it will be apparent that there is still a need for a USB flash memory device that provides yet a higher level of data security to protect data stored on thereon.

### BRIEF DESCRIPTION OF THE DRAWINGS

FIG. 1 is a block diagram illustrating a use scenario of a USB flash memory device.

FIG. 2 is a block diagram illustrating a high-level view of the architecture of a prior art USB flash memory device having a USB flash memory microcontroller and a NAND memory storage area.

FIG. 3 is a block diagram illustrating a high-level view of the architecture of a USB flash drive incorporating a smart card circuit operating in cooperation with a USB microcontroller.

FIG. 4 is a block diagram illustrating an exemplary layout of the addressable space of the memory of the flash memory of the USB flash drive of FIG. 3.

FIG. 5 is a block diagram illustrating a high-level view of the architecture of a smart card module of FIG. 3.

FIG. 6 is a schematic illustrating of a computer network and illustrates the participants in a firmware update for a USB flash drive of FIG. 3.

FIG. 7 is a timing sequence diagram illustrating the interaction between the various entities of FIG. 6 to ensure that only a valid and certified firmware update is installed.

FIG. 8 which is a block diagram illustrating the components of the firmware update package.

FIG. 9 is a schematic illustrating a problem that occurs when multiple USB flash drives are inserted into the same host computer.

FIG. 10 illustrates a user interface interaction window of the partition resize tool of the unlock application after the autolaunch of the unlock application.

FIG. 11 is a block diagram illustrating the architectural components of the USB flash drive SC.

FIG. 12 is a timing sequence diagram illustrating the message flow and actions taken by the host computer executing the unlock application.

FIG. 13 is a table illustrating one example of an association table constructed according to the method of FIG. 12.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment of the invention, a USB flash drive having a smart card module operating in conjunction with the USB flash drive microcontroller provides an hitherto unavailable level of security. Furthermore, a USB flash drive having a smart card as described herein provides for a secure mechanism to coordinate that any parameter updates to the USB flash drive are performed securely and in a manner so that the smart card's capability for parameter update is utilized while communicating parameter updates to the USB flash drive microcontroller.

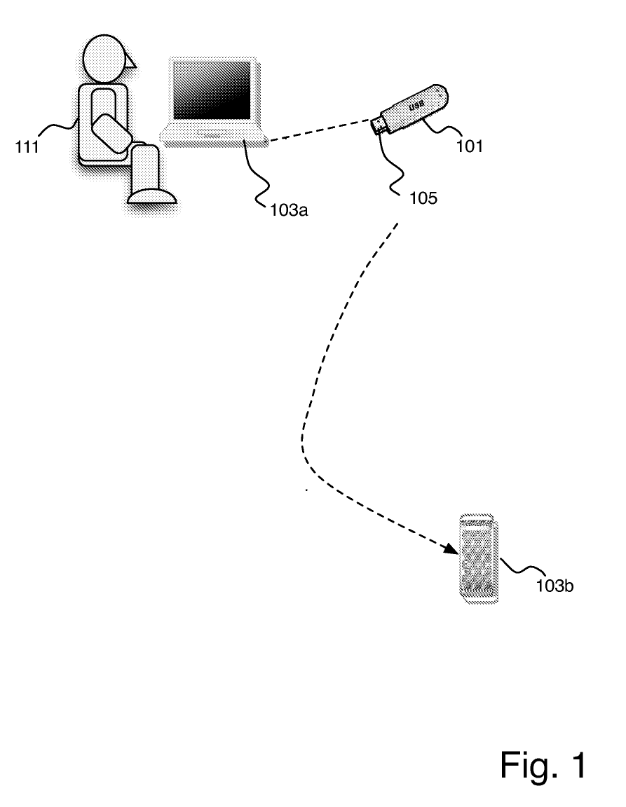

FIG. 1 is a schematic diagram illustrating a typical use of a USB flash drive 101. A user 111 operates a computer 103. On that computer the user 111 has stored certain files (not shown). It is often the case that a computer user 111 needs to access these same files at other locations. For example, a user 111 may need to access a file, which was created on a work computer, using his home computer 103. One way to transfer the file would be via a computer network or by sending the file via electronic mail. However, that may not always be practical.

An alternative is to physically move a copy of the file on a storage medium. USB flash drives 101 is one such storage medium. In the example of FIG. 1, a USB flash drive 101a having a USB connector 105 is inserted into a USB port of the user's computer 103a. The USB flash drive 101a then enumerates on the user's computer 103a¹. ¹ Herein, letter suffixes are used in conjunction with reference numerals to designate specific instantiations of a class of objects having common generic features. The class is referred to using numerals only. Thus, 103a is a specific computer 103. Any reference to a device solely by a numerical reference is meant to apply equally to all members of the class unless the context prohibits such an interpretation.

USB enumeration process includes performing a reset operation of a USB flash drive 101 and the USB flash drive 101 is assigned a unique identifier. In the case of a USB mass storage device, like a USB flash drive 101, a drive letter is assigned to the USB flash drive 101 so that a user 111 can access the USB flash drive 101 from his computer. Thus, at the conclusion of the enumeration process the USB flash drive 101 has been assigned a drive letter, e.g., “H:” or “K:”, by which the USB flash drive 101 is uniquely identified in the computer's operating system.

After the user 111 has inserted the USB flash drive 101a into the computer 103a and the USB flash drive 101a has enumerated, the user 111 can copy files from the computer 103a to the USB flash drive 101a. At this point, the files have become physically portable and the user 111 can move the files to another computer 103b by inserting the USB flash drive 101a into a USB port of that computer 103b. The user 111 can now read the file using the file browser or application programs on that computer 103b.

Of course, as with other storage drives on a computer, a USB flash drive 101 may be used to create, read, delete and otherwise manipulate files as permitted by the operating system and application programs running on the computers to which it is connected 103.

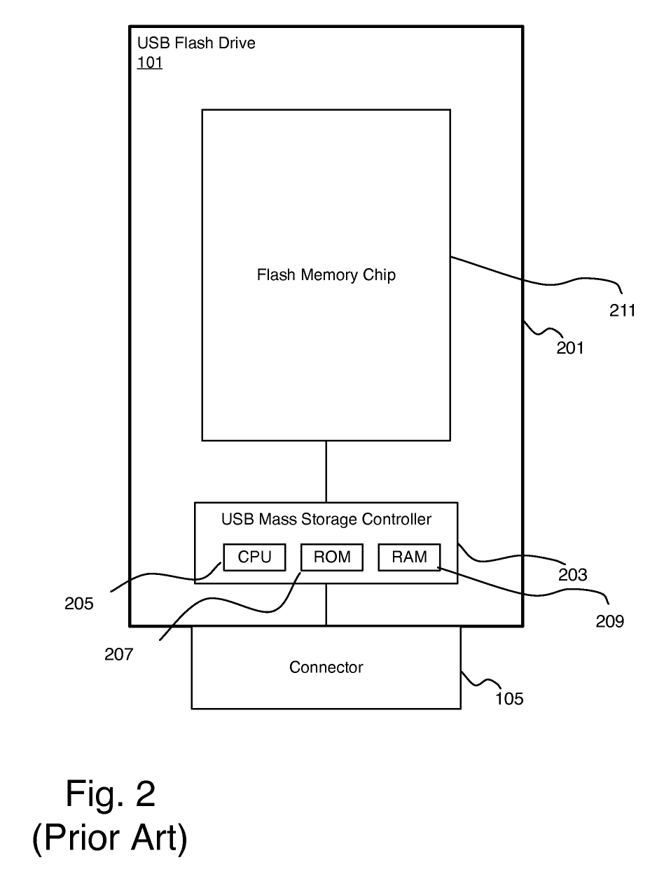

FIG. 2 is a high-level block diagram illustrating the basic components of a prior art USB flash drive 101. A USB flash drive 101 typically has a hard shell housing 201, e.g., plastic or aluminum, to contain and protect the internal components of the USB flash drive 101. At one end, the USB flash drive 101 has a connector for connecting the USB flash drive 101 to a host computer 103 and to provide a communications interface to the host computer 103 to which it is connected.

A prior art USB flash drive 101 further contains a USB mass storage controller 203. Flash memories are block-oriented and are subject to wear (a limit on the number of read-write cycles that a flash memory can handle). The USB mass storage controller 203 implements a USB host controller and provides a linear interface to block-oriented serial flash devices while hiding the complexities of block-orientation, block erasure, and wear leveling, or wear balancing. The controller contains a small RISC microprocessor 205 and a small amount of on-chip ROM 207 and RAM 209.

A USB flash drive 101 further contains a flash memory chip 211, typically a NAND flash memory chip, for storing data, e.g., computer files.

A USB flash drive 101 further contains a crystal oscillator for producing a clock signal, and may contain LEDs, write protect switches, and a myriad of non-electrical components for aesthetic or portability purposes. These are not important to the present discussion.

As discussed hereinabove, the mainstream prior art USB flash drive 101 is extremely vulnerable to security threats. These devices provide no defense against the risk that the data stored thereon would come into the wrong hands if the device is stolen or lost. Furthermore, when inserted into a stranger's computer 103, the data on a USB flash drive 101 may be either inadvertently or intentionally copied to that computer 103 or be deleted from the USB flash drive 101.

As further discussed hereinabove, there are prior art approaches to provide a certain level of security through the use of encryption services provided directly on the microcontroller 205. An alternative, that provides yet higher security, using a smart card module for providing certain security features is presented here.

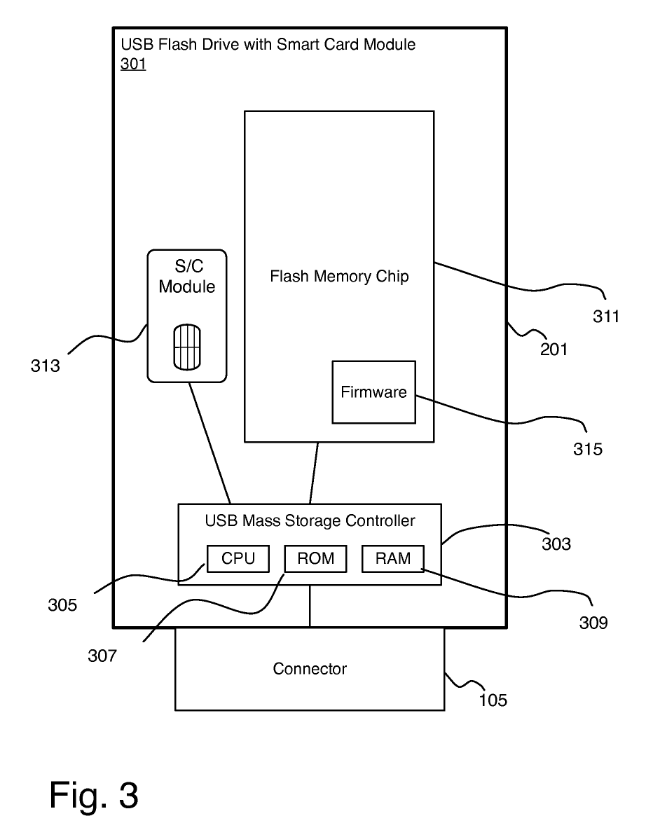

FIG. 3 is a block diagram illustrating a high-level view of the architecture of a USB flash drive 101 incorporating a smart card module for providing security functionality, e.g., authentication and cryptographic services, to enhance the security of data stored on the USB flash drive 101 (referred to hereinafter as a USB flash drive SC).

As with the prior art USB flash drive 101, a USB flash drive SC 301 is constructed with a USB connector 105 at one end, and has a USB flash drive microcontroller 303 having a microprocessor 305, a ROM 307, and a RAM 309, as well as a flash memory chip 311. Additionally the USB flash drive SC 301 contains a smart card module 313 connected to the USB flash drive microcontroller 303.

In one embodiment, the smart card module 313 is used by the USB flash drive SC 301 to authenticate a user and to provide certain cryptographic capabilities. Thus, for example, when the USB flash drive SC 301 is inserted into a computer 103, a logon screen may be presented to the user 111 requesting the user 111 to authenticate himself using a PIN or password. Authentication is then entirely a negotiation between the host computer 103 and the smart card module 313 with only the result presented to the USB flash drive microcontroller 303.

In one embodiment, the communication between the host the computer and the USB flash drive SC 301 is performed using the USB mass storage protocol and the USB CCID (Chip Card Interface Device) protocol.

Operations of the USB flash drive microcontroller 303 are according to instructions stored in a firmware control program 315 stored in the flash memory 311. The firmware control program 315 contains start-up instructions executed on initialization of the USB flash drive SC 301. Several of the start-up procedures are discussed in greater detail hereinbelow.

As discussed hereinabove, USB enumeration is one function performed during startup. The USB flash drive SC 301 enumerates itself as a plurality of a USB mass storage drives and as a smart card interface device (akin to a USB smart card reader) to allow for communication using the CCID protocol. The firmware control program 315 contains the necessary instructions to act as a CCID device when the host computer 103 directs communication to the smart card module 313.

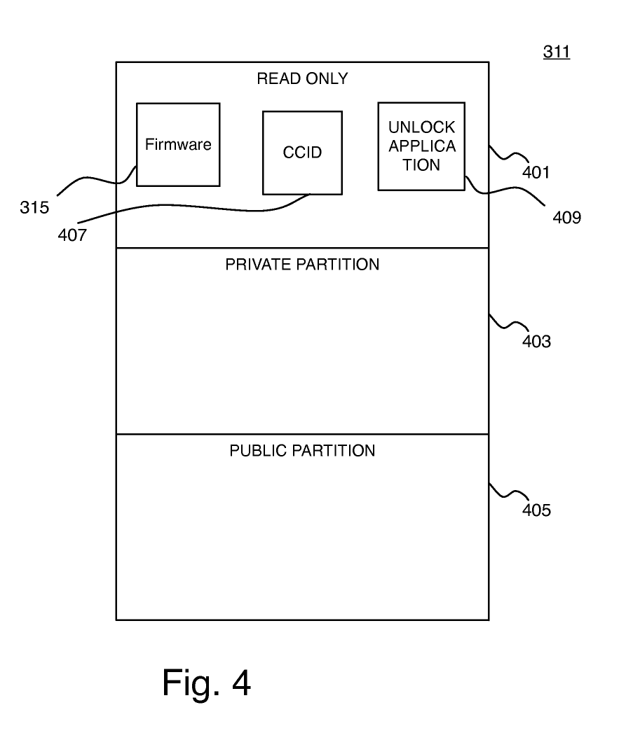

FIG. 4 is a block diagram illustrating an exemplary layout of the addressable space of the memory of the flash memory 311. In one embodiment, the addressable space of the flash memory is partitioned into three partitions: a read only partition 401, a private data partition 403, and a public data partition 405.

The read only partition 401 contains the control program firmware 315 and a CCID module 407 for managing interaction with the host computer 103 over the CCID protocol. In alternative implementations, the communication with the smart card module 313 is carried over the USB Human Interface Device (HID) protocol, or any other suitable communications protocol. For such alternatives, the CCID module 407 would be replaced with communications modules appropriate for such protocols allowing the USB flash drive SC 301 to enumerate as such a device, e.g., as an HID device.

The read only partition 401 also contains a host computer application program, the unlock application 409. The unlock application 409 may be an autorun application that automatically launches on the host computer 103 or may appear as a launchable application when the read only partition 401 is browsed to using the host computer 103 operating system.

The unlock application 409 may be used by a user 111 to perform several tasks associated with managing the USB flash drive SC 301. The unlock application 409 may, for example, be used by the user 111 to authenticate to the USB flash drive SC 301.

The USB flash drive SC 301 enumerates as three USB mass storage partitions, one corresponding to the read only partition 401, one as the private partition 403 and one as the public partition 405.

Upon initialization of the USB flash drive SC 301, the private partition 403 enumerates as a drive without media, i.e., a user 111 would be able to see a drive letter designated for the drive, however, it would appear as an empty disk drive.

Through the unlock application 409 the user 111 may unlock the private partition 403 to have access to files stored therein. In one embodiment, data in the private partition 403 is encrypted using an AES key (e.g., a 256 bit key). The AES key is stored in the smart card module 313. When the user 111 has authenticated using the unlock application 409 the smart card module 313 encrypts the AES key in a manner in which the USB flash drive microcontroller 303 can decrypt. The USB flash drive microcontroller 303 then uses the decrypted AES key to decrypt information stored in the private drive. The USB flash drive microcontroller 303 stores the AES key only temporarily. Thus, when the USB flash drive SC 301 is removed from the host computer 103 the AES key is only stored in the smart card module 313.

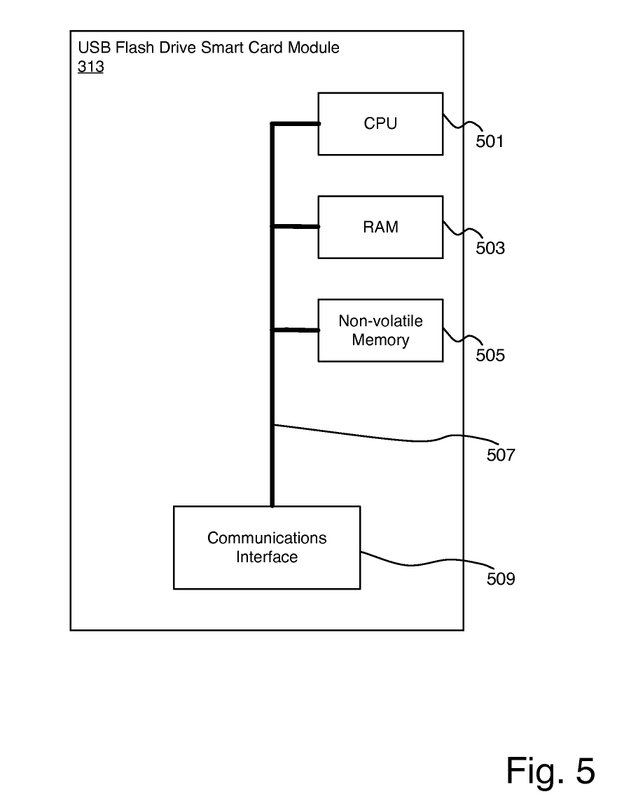

FIG. 5 is a block diagram illustrating a high-level view of the architecture of a smart card module 313 used in the USB flash drive SC 301. The smart card module 313 contains a central processing unit 501, a RAM 503, and a non-volatile memory 505. These components are connected via a bus 507. Also connected to the bus 507 is a communications interface 509 for providing a connection between the bus 507, and consequently, the CPU 501, RAM 503, and non-volatile memory 505, and the USB flash drive microcontroller 303.

In one embodiment communication between the USB flash drive microcontroller 303 and the smart card module 313 is over the ISO-7816 APDU protocol. Several special instructions are added to facilitate particular interactions required for coordinating the operations of the smart card module 313 and the USB flash drive microcontroller 303.

Smart card modules are often well suited for storing small pieces of data whereas USB flash drives are better suited for dealing with large chunks of data. For example, a smart card may be used to store individual pieces of information such as decryption keys or dollar balances in an electronic purse application. USB flash drives on the other hand are typically used to store large data units such as entire data files.

The relative suitability of a smart card module 313 for storing smaller data items may be exploited by using the smart card module 313 for storing parameters that control the operation of the USB flash drive 101. It is also advantageous to use the smart card module 313 for storing parameters that impact the overall security solution. One such set of parameters is the relative sizes of the partitions of the flash memory 311.

Flash memories come in many different sizes. Common sizes include 256 MB, 516 MB, 1 GB, and 2 GB. However, it is likely that larger sizes will become increasingly common. It is desirable that a particular smart card module 313 does not need to be aware of the size of the flash memory 311 of the USB flash drive SC 301, that the particular smart card module 313 is part of. Therefore, in one embodiment of the invention the smart card module 313 refers to the relative partition sizes by percentages by default and through interaction with the USB flash drive microcontroller 303 the smart card module 313 obtains the actual memory addresses associated with particular partitions if necessary.

In one embodiment, the smart card module 313 is used to store the partition sizes. A user 111 may be able to change the partition sizes through interaction with the unlock application 409. More generally, the smart card module 313 may be used to store a parameter list defining properties of the USB flash drive 101.

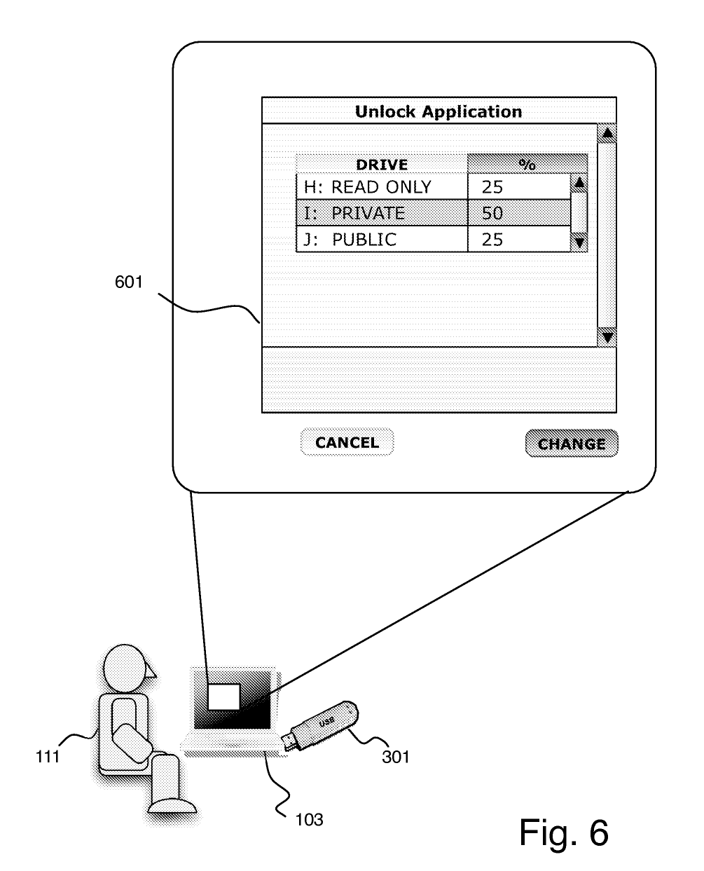

FIG. 6 is a block diagram illustrating the interaction between a user 111 and the unlock application 409. The unlock application 409, which is either autolaunched from the read-only partition 401 of the flash memory 311 or manually started, e.g., by clicking on an icon associated with it in an operating system browser, may be used for a variety of tasks associated with the operation of the USB flash drive SC 301, for example, to authenticate to the USB flash drive SC 301. One such task is resizing the partitions of the flash memory 311.

A screen on the user's 111 computer 103 may display a window 601 containing size information for the partitions. The user 111 may through interaction with that window 601 change relative drive sizes. In an alternative embodiment, actual sizes or addresses for the partitions are displayed and altered by the user 111.

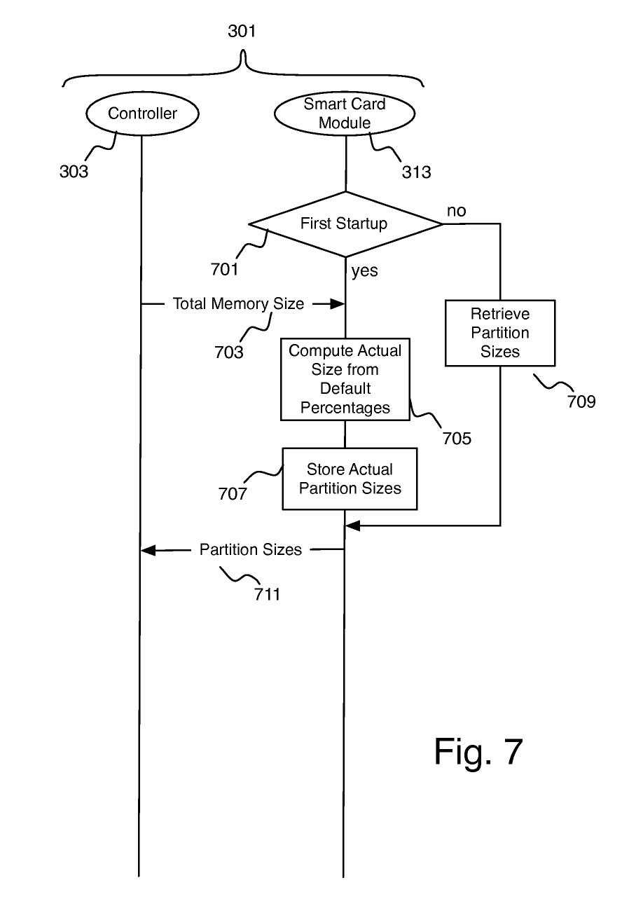

FIG. 7 is a timing sequence diagram illustrating the startup logic of the USB flash drive SC 301.

Upon insertion of the USB flash drive SC 301, the smart card module 313 determines if this is the first time the smart card module 313 has been started up within the USB flash drive SC 301, step 701. If so, the smart card module 313 only knows default percentage values for the various partitions. These can be set on an enterprise level during an enterprise-wide deployment of USB flash drive SCs 301.

If it is a first start-up, the smart card module 313 obtains a total memory size from the USB flash drive microcontroller 303, step 703, and computes the actual partition sizes based on the total memory size and the default percentages, step 705. The smart card module 313 then stores those values in NVM 505, step 707.

If, on the other hand, it is not a first startup, the smart card module 313 already has stored in NVM 505 the partition sizes. The smart card module 313 then retrieves the partition values, step 709.

Regardless of whether the startup is a first startup or not, the smart card transmits the partition sizes to the USB flash drive microcontroller 303, step 711. The USB flash drive microcontroller 303 may then use that information to determine which areas are protected as private areas and which are public areas.

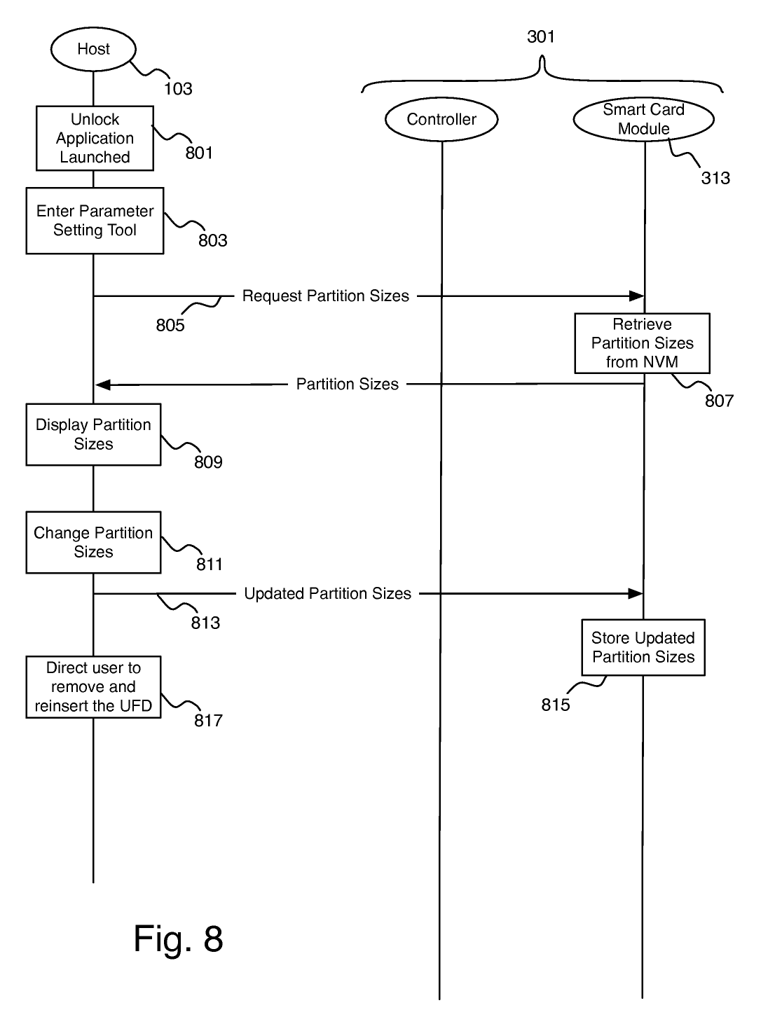

FIG. 8 is a timing sequence diagram illustrating the update of parameters, e.g., partition sizes. The unlock application 409 is launched on the host computer 103 from the read-only partition 401 of the flash memory 311. This may be accomplished through either an autolaunch or by manual start from an operating system browser.

The user 111 navigates in the unlock application 409 to a parameter setting tool, step 803. Instructions in the unlock application 409 instruct the host computer 103 to issue a RequestPartitionSize instruction to the smart card module 313, step 805. The smart card module 313 retrieves the partition sizes from NVM 505, step 807, and responds to the host computer 103 with the partition sizes, step 809.

The unlock application 409 then displays the partition sizes in the dialog window 601 on the user's 111 computer 103, step 811. If the user 111 makes a change to the partition sizes, the updated partition sizes are transmitted to the smart card module 313, step 813. The smart card module 313 then updates the partition sizes in NVM 505, step 815.

In one embodiment the partition sizes are not updated at this point in the USB flash drive microcontroller 303. In this embodiment, illustrated in FIGS. 7 and 8, to update the partition sizes as viewed by the USB flash drive microcontroller 303, the USB flash drive SC 301 should be reinitialized by being removed and reinserted into the host computer 103. Therefore, the user 111 is prompted to do so by the unlock application 409, step 817.

It should be noted that in one embodiment, prior to being able to update parameters such a partition size, the user 111 may be required to authenticate himself as an administrator of the USB flash drive SC 301. Both the unlock application 409 and the smart card module 313 may enforce that requirement. For example, some enterprises' security policies may not allow end-users to change partition size or to even have a public partition on the USB flash drive SC 301. To remove a partition, e.g., the public partition, that partition's size is merely set to zero.

From the foregoing it will be apparent that a USB flash drive SC 301 provides an efficient, flexible, and secure mechanism for maintaining modifiable partition sizes between read-only, private and public memory areas of the flash memory. The same mechanism may be employed for other operating parameters of the USB flash drive SC 301.

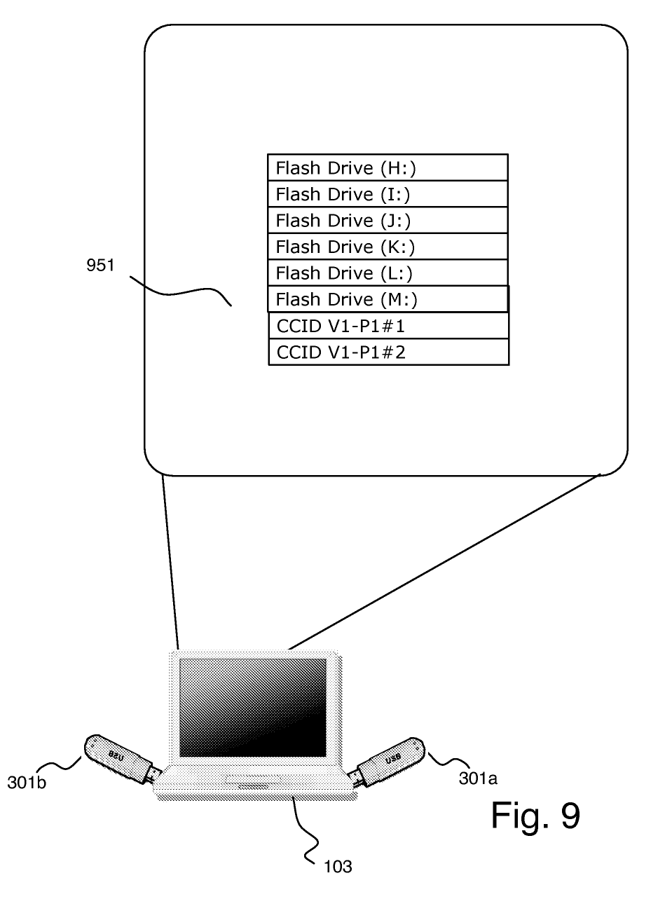

FIG. 9 is a schematic illustrating a problem that occurs when multiple USB flash drives SC 301a and 301b are inserted into the same host computer 103. Each drive enumerates their respective flash memory as multiple USB mass storage drives and as a USB CCID reader. A browser window 951 (somewhat simplified for the purposes of illustration) would show each of the drives with their own drive letters and the CCID devices with some unique identifier, e.g., a combination of Vendor ID, Part ID, and a counter value.

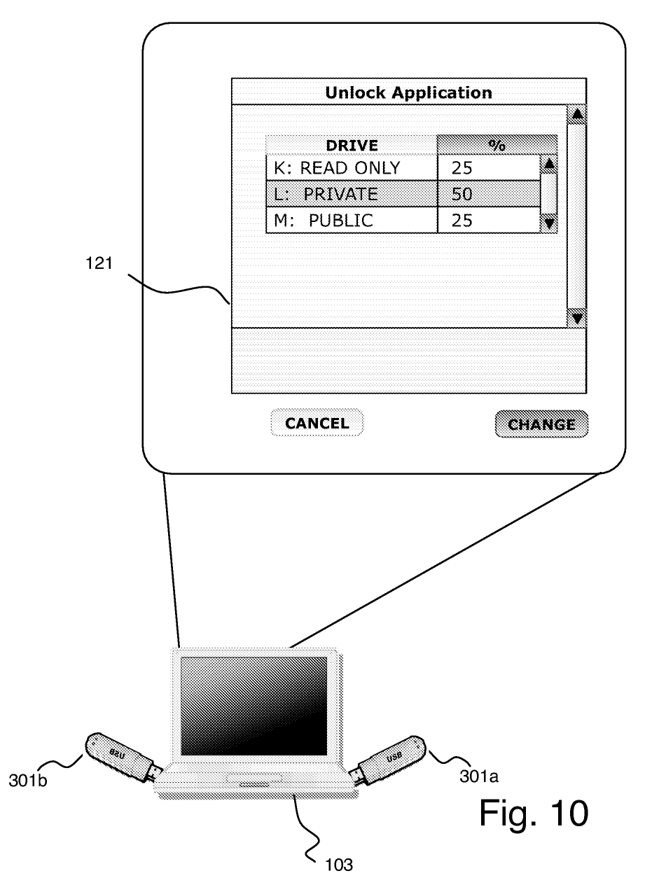

FIG. 10 illustrates a user interface interaction window 121 of the partition resize tool of the unlock application 409 after the autolaunch of the unlock application 409 after the insertion of the second USB flash drive SC 301b or after a manual start of the unlock application 409 from the operating system browser. The interface interaction window 801 correctly shows the linkage of the particular unlock application 409 instance with the drives associated with that particular unlock application 409 instance.

As discussed hereinabove, the actual parameter setting from the unlock application 409 is performed in conjunction with the smart card module 313 that corresponds to the drives associated with the flash memory 311 in the same USB flash drive SC 301. However, because the smart card module 313 and the USB flash drive microcontroller 303 are independently enumerated, the host computer 103 operating system would not directly have that linkage available. To make that information available to the unlock application 409, the USB flash drive microcontroller 303, smart card module 313, and the unlock application 409 cooperate to build a table having those associations.

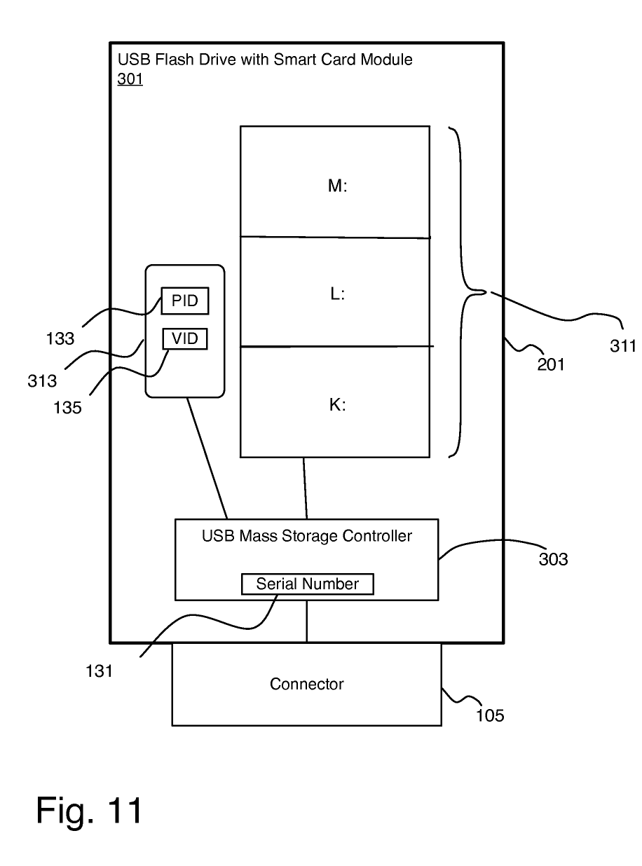

FIG. 11 is a block diagram illustrating the architectural components of the USB flash drive SC 301 that are used to build that association table between a smart card module 313 and the drives that are associated with it. The flash memory 311 is divided into a plurality of partitions, each of which is given a drive letter when the USB flash drive SC 301 goes through the USB enumeration process. In the example, the flash memory 311 is divided into partitions corresponding to drives K:, L:, and M:. Each USB flash drive microcontroller 303 has a unique serial number 131 associated therewith. The smart card module 313 has a product identifier (PID) 133 and a vendor identifier (VID) 135. A smart card module 313, at startup, responds to a PowerUp instruction with an Answer to Reset (ATR) response. The ATR contains the VID and PID. When multiple CCID devices enumerate on the same host computer 103, these will be assigned a unique sequence number, e.g., VID-PID-1, VID-PID-2.

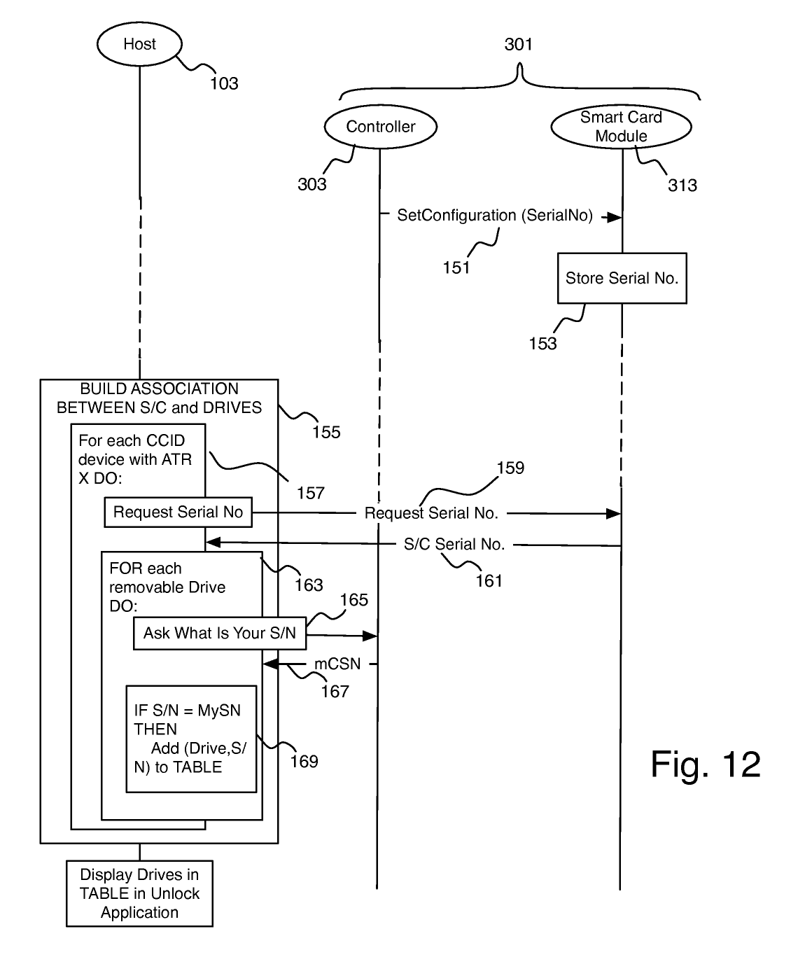

FIG. 12 is a timing sequence diagram illustrating the message flow and actions taken by the host computer 103 executing the unlock application 409, the USB flash drive microcontroller 303 and the smart card module 313 build an association table between a particular smart card module 313 and the drives associated with the smart card module 313.

On initialization of the USB flash drive SC 301, the USB flash drive microcontroller 303 transmits the serial number 901 of the USB flash drive microcontroller 303 to the smart card module 313, message 151. The smart card module 313 stores that serial number in NVM 505, step 153. Thus, this step may not necessarily need to be performed on every start up but could be reserved for the very first time the USB flash drive SC 301 is initialized. Alternatively, it may be performed at the direction of the smart card module 313 when needed to answer a query from the unlock application 409.

At some later point in time, indicated by the dashed lines in FIG. 10, the unlock application 409 requires the association between the smart card module 313 and the drives associated with the corresponding USB flash drive microcontroller 303. The unlock application 409 then directs the host computer 103 to perform steps (instruction sequence 155) to build an association table between the drives and the smart card module 313.

The unlock application 409 knows the expected ATR of the smart card modules 313 that correspond to it. If other CCID devices, e.g., from other manufacturers, are connected to the host computer 103, those devices present different ATRs. The unlock application 409 exploits that knowledge by, for each CCID that has a matching ATR to do the following (FOR loop 157):
Request the serial number, message 159. In response the smart card module 313 answers with the serial number (S/C Serial No) provided by the USB flash drive microcontroller 303 in step 151, message 161.
For each removable drive (inherently fixed drives cannot be associated with a partition in a USB flash drive SC 301, thus those may be skipped), perform the following steps (FOR loop 163):
   Request the USB flash drive microcontroller 303 for that drive to return its serial number, message 165.
   The USB flash drive microcontroller 303 responds with the serial number (mCSN), message 167.
   If the two serial numbers (S/C Serial No. and mCSN) are equal, the tuple (drive letter, serial no.) is added to the table, step 169.

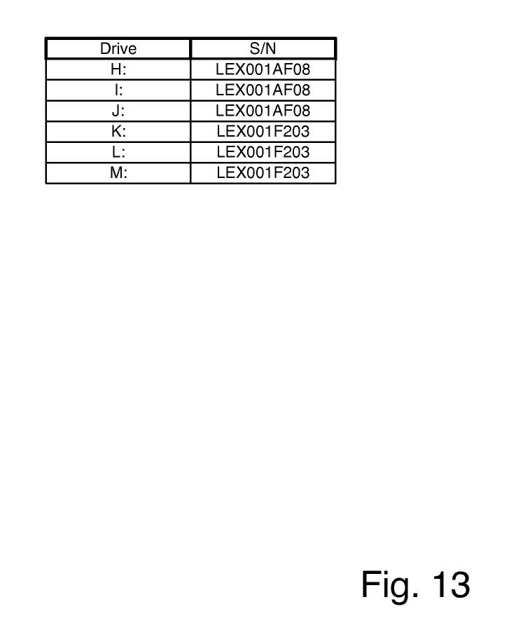

FIG. 13 is a table illustrating one example of an association table constructed according to the method of FIG. 12. It should be appreciated that the drive letters are uniquely assigned by an host computer 103 on each start up of a device and that the serial numbers shown in the table are merely for purposes of example and have little if no resemblance to actual serial numbers used in an implementation of a USB flash drive SC 301 as described herein.

FIG. 12 illustrates one embodiment of a process to building an association table between smart card modules 313 and the drives associated with that smart card module 313. Other data flows are possible. For example, in an alternative embodiment the two for loops are reversed so that the outer-loop loops over removable drives and the inner-loop loops over smart card modules 313 that match the serial number of the removable drive.

Having built the table, the unlock application 409 may use the information therein to control the individual drives associated with each particular smart card module 313, e.g., to display the drives in a parameter setting tool as illustrated in FIG. 8.

From the foregoing it will be apparent that a USB flash drive SC as described herein provides an efficient, flexible, and secure mechanism for establishing associations between particular USB mass storage drives associated with flash memory partitions, e.g., for read-only, private and public memory areas of the flash memory, and smart card modules that control parameters controlling these partitions. Providing such associations enable the use of multiple USB flash drives having smart cards for managing security functions and parameter settings for such USB flash drives wherein the smart cards are enumerated separately from the partitions in the flash memory.

Although specific embodiments of the invention have been described and illustrated, the invention is not to be limited to the specific forms or arrangements of parts so described and illustrated. The invention is limited only by the claims.

We claim:

1. A method of operating a system having a host computer connected to a plurality of flash drives to associate updates to an operating parameter with a correct flash drive, comprising:
enumerating a first microcontroller of each flash drive as a plurality of storage drives wherein the first microcontroller has associated therewith a unique serial number;
enumerating a second microcontroller of each flash drive as a peripheral device of a second type wherein the second microcontroller has associated therewith a product identifier (PID) and a vendor identifier (VID) and an enumeration number for device with identical PID and VID;
upon initialization of one of the plurality of flash drives, transmitting the serial number of the first microcontroller to the second microcontroller;
establishing an association between the second microcontroller of each flash drive and the serial number the second microcontroller received from the first microcontroller;
creating an association between the plurality of storage drives corresponding to each first microcontroller and the corresponding second microcontroller using the established association between the first microcontroller and the second microcontroller based on the received serial number of second microcontroller;
displaying to a user the association between the plurality of storage drives corresponding to a first microcontroller and a particular flash drive;
receiving from the user a request to change a parameter associated with the particular flash drive;
transmitting the request to change a parameter from the host computer to the second microcontroller of the particular flash drive; and
operating the second microcontroller according to the changed parameter.

2. The method of claim 1 wherein the step of establishing an association between the second microcontroller and the serial number comprises transmitting the serial number from the second microcontroller to the host computer in response to a query to the second microcontroller from the host computer.

3. A method of operating a system having a host computer and a device having two independent processors to all a second processor to be used to store and otherwise manipulate a parameter of the first processor, by associating addressable units corresponding to a first processor of a device with a second processor of the device wherein the addressable units corresponding to the first processor enumerates independently from the second processor, comprising:
associating a serial number with a first processor of the device and being of a first type;
associating the serial number with all the addressable units corresponding to the first processor;
associating a unique identifier with a second processor of the device and being of a second type;
transmitting the serial number from the first processor to the second processor;
transmitting the serial number from the first processor to the host computer in response to a query directed to the first processor by the host computer;
on receiving the serial number from the second processor, querying each addressable unit of the first type as to whether the addressable unit is associated with the serial number received from the second processor.

4. The method of claim 3 wherein the query is transmitted from the host computer by a user application executing on the host computer wherein the user application transmits a query to each device of the second type to identify the serial number of the first processor of the device to which the second processor belongs.
